(19) United States
(12) Patent Application Publication
(10) Pub. No.: US 2011/0303552 A1
(43) Pub. Date: Dec. 15, 2011

(54) ONE STEP ELECTROCHEMICAL PROCESS FOR THE SYNTHESIS OF PURE RUTILE TITANIUM DIOXIDE NANONEEDLES

(76) Inventors: Rajeshkumar Shankar Hyam, Maharashtra (IN); Reshma Kanta Bhosale, Maharashtra (IN); Satishchandra Balkrishna Ogale, Maharashtra (IN)

(21) Appl. No.: 13/144,601

(22) PCT Filed: Jan. 12, 2010
(86) PCT No.: PCT/IN2010/000022

§ 371 Date: Jul. 28, 2011

(30) Foreign Application Priority Data
Jan. 12, 2009 (IN) 49/DEL/2009

(51) Int. Cl. C25B 1/00; B82Y 40/00

(52) U.S. Cl. 205/538; 977/899

(57) ABSTRACT

A one step, room temperature, electrochemical process for the synthesis of rutile titanium dioxide nanoneedles with high aspect ratio is disclosed herein.

### FIELD OF THE INVENTION

The invention relates to a one step electrochemical process for the synthesis of pure rutile titanium dioxide nanoneedles with high aspect ratio at room temperature. Further the invention relates to a room temperature process for the synthesis of rutile titanium dioxide nanoneedles.

### BACKGROUND AND PRIOR ART

Titanium dioxide occurs in nature as rutile, anatase and brookite. Rutile titanium dioxide is widely used as ultraviolet protecting agent, optical coatings, beam splitters and anti-reflection coatings. It can also be used as a humidity sensor and as high-temperature oxygen sensor.

A variety of synthetic procedures have been documented for control on the phase formation and morphology of TiO₂ nanoparticles. Usually, these synthetic routes lead to mixture of anatase and rutile polymorphs.

Rutile TiO₂ powders are conventionally obtained by phase transformation of anatase to rutile at more than 450° C. or by flame oxidation of TiCl₄. These methods result in larger titania particles with lower surface/volume ratio. The alternative to control the phase and size of rutile titania particles involves the use of a precursor along with other mineralizers and inorganic additives, like SnCl₄, NH₄Cl, NaCl or SnO₂ that are difficult to remove and have an undesirable influence in several applications. Controlled synthesis of crystalline rutile nano-TiO₂ without using any inorganic additives require higher temperatures, which result in an increase in crystallite size. Low-temperature preparation of nano-rutile TiO₂ with higher specific surface area is possible under acidic conditions by hydrothermal synthesis route. But, this process is extremely time consuming, requiring about two-three days with poor yields.

WO2008127508 titled “Titania Nanotubes Prepared By Anodization In Chloride-Containing Electrolytes” by Northeastern University dated 23 Oct. 2008; discloses a method of preparing titania nanotubes on the surface of Ti foil leading to rapid production of titania nanotubes of about 25 nm diameter and high aspect ratio, which can be organized into bundles and tightly packed parallel arrays. This application discloses use of Ti foil as anode and platinum rod as cathode with an electrolyte solution consisting of chloride ions and the reaction is carried out at room temperature with a pH ranging 1 to 7. But Ex. 4 refers to the X-ray diffraction of TiO₂ nanotubes, wherein the as-synthesized samples were amorphous prior to annealing and the annealed samples were predominantly anatase with traces of rutile.

Nakayam et al in “Anodic formation of high aspect ratio titania nanotubes”, ECS Meeting Abstracts 502, 819(2006) reported an anodization process for the preparation of anatase TiO₂, the material formed by the Nakayama et at process was nanotubes. The nanotubes were formed on the surface of Ti foils.

Juha-Pekka et al in an article titled “The effect of acidity in low-temperature synthesis of titanium dioxide” in Journal of crystal growth 2007, Volume 34, No 1, 179-183 disclose preparation of crystalline titanium dioxide powders by the modified alkoxide method of low temperature. They further state that lower acidity promotes anatase phase, while in case of higher amount of acid the final phase form is rutile.

Aruna et al. in Journal of Materials Science 2000, 10, 2388-2391 and Zhang et al. in Langmuir 2003, 19, 967-971 titled “Preparation of Oxide Nanocrystals with Tunable Morphologies by the Moderate Hydrothermal Method: Insights from Rutile” prepared nanosize rutile titania by hydrothermal and thermal hydrolysis of titanium(IV) isopropoxide (Ti[OCH(CH₃)₂]) and titanium(IV) chloride (TiCl₄) respectively.

Pedraza et al. in Journal of Physics and Chemistry of Solids 60 (1999) 445-448 showed room temperature preparation of high surface area rutile TiO₂ using TiCl₃ in O₂. But the processes followed by Aruna et at and Pedraza et al led to formation of spherical or irregularly shaped rutile titania nanoparticles. Amorphous precipitates of rutile titania nanocrystals have been obtained by hydrothermal treatment or peptization of titanium alkoxide at 433-573 K. Keisuke Nakayam et. al. in Electrochemical and Solid-State Letters, 11 (3) C23-C26 (2008) have disclosed an anodization process for the preparation of TiO₂, which resulted in anatase TiO₂ as nanotubes.

Thus we observe that prior art processes to prepare rutile titania are spontaneous, with little or no control on morphology, unless templates are employed. Further, the results of the prior art processes is a mixture of spherical, broom like, or rod-shaped rutile titania. Also, the separation of nanocrystals of any particular morphology from the others is very tedious. Further no prior art process disclose a single-step room temperature process to synthesize rutile titania nanoneedles. Also, the prior art processes suffer from the drawback of having to conduct processes above room temperature, about 50° C.

Therefore there exists a need from prior art review to evolve a simple, preferably single step process for the synthesis of rutile titanium dioxide at room temperature. There also exists a need to evolve a process for the synthesis of TiO₂ with control on morphology.

Also, there exists a need to synthesize rutile titanium dioxide nanoneedles by a simple process that is carried out at room temperature, which results in nanoneedles of high aspect ratios (ratio of length to diameter).

### SUMMARY OF THE INVENTION:

Accordingly, the present invention provides a one step electrochemical process for the synthesis of pure rutile titanium dioxide nanoneedles with high aspect ratio at room temperature. The process involves application of electric field between a cathode made of noble metal and Ti as anode within a bath comprising of acid and water of desired pH. The nanoneedles of rutile TiO₂ are formed by the dissolution of Ti anode. The aspect ratio of the nanoneedles is greater than 10.

In an embodiment, a one step electrochemical process for the synthesis of pure rutile titanium dioxide nanoneedles with high aspect ratio at room temperature, wherein the said process comprising the steps of :
a. maintaining a bath of a solution of mineral acid in water at temperature ranging from 20-30° C., wherein the cathode is a noble metal and the anode is Ti;
b. applying electric voltages of the order of 8-30 volts between the two electrodes of step (a) stationed at about 1-2 cms apart, resulting in the instantaneous evolution of hydrogen gas at cathode and anodic dissolution of Ti into pure rutile TiO₂ nanoneedles in the bath ;
c. washing the nanoneedles as obtained in step (b) and air-drying at ambient temperature ranging between 20-30° C. to obtain rutile titanium dioxide nanoneedles with aspect ratio greater than 10.

In yet another embodiment, a process as claimed in claim 1, wherein noble metal used for cathode in step (a) is platinum.

In yet another embodiment, a process as claimed in claim 1, wherein mineral acid used in step (a) is HClO₄.

In yet another embodiment, a process as claimed in claim 1, wherein pH of the acid solution is below 2.

In yet another embodiment, a process as claimed in claim 1, wherein Ti anode used in step (a) is selected from the group wire, foil, plate and rod.

In yet another embodiment, a process as claimed in claims 1, Ti anode used in step (a) is a foil.

In yet another embodiment, a process as claimed in claim 1, wherein current density in the foil surface is in the range of 80-120 mAmps/cm² for rutile phase titanium dioxide nanoneedles formation.

In yet another embodiment, a process as claimed in claim 1, wherein thickness of Ti anode foil is at least 0.5 mm.

### DESCRIPTION OF DRAWINGS

FIG. 1 shows the XRD for phase pure rutile TiO₂ nanoneedles.

FIG. 2 shows HR-TEM (High Resolution—Transmission Electron Microscopy) picture of as synthesized rutile TiO₂ nanoneedles.

FIG. 3 shows HR-TEM. The interplanar spacing was compared with standard PCPDFWIN data 211276 and matches with the 110 plane of rutile TiO₂.

FIG. 4 shows the SAED pattern of the room temperature synthesized rutile TiO2 nanoneedle powder. The diffraction rings are matching with that of rutile TiO₂ (PCPDFWIN data 211276).

### DETAILED DESCRIPTION OF INVENTION:

In order to achieve the objectives of the invention, a one step, room temperature electrochemical process for the synthesis of rutile titanium dioxide nanoneedles with high aspect ratio is disclosed herein.

The one step room temperature electrochemical process for the synthesis of rutile titanium dioxide nanoneedles with high aspect ratio comprises:
a) maintaining a bath of a solution of mineral acid in water at temperature ranging from 20-30 deg C., wherein the cathode is a noble metal and the anode is Ti;
b) applying electric voltages of the order of 8-30 volts between the two electrodes of step (a) stationed at about 1-2 cms apart, resulting in the instantaneous evolution of hydrogen gas at cathode and anodic dissolution of Ti into rutile TiO₂ nanoneedles in the bath and
c) washing the nanoneedles of step (b) and air-drying at ambient temperature to obtain rutile titanium dioxide nanoneedles of the invention with high aspect ratio.

The concentration of the acid solution is such that the pH is below 2. The mineral acid of the invention is HClO₄.

The cathode of the process of the invention is selected from the group comprising of noble metals with high conductivity, preferably platinum.

Ti is in a physical form selected from wire, foil, plate, rod and such like, preferably foil. The Ti used is phase pure and preferably of a thickness of at least 0.5 mm. The current density in the foil surface is 80-120 mAmps/cm² for rutile phase formation.

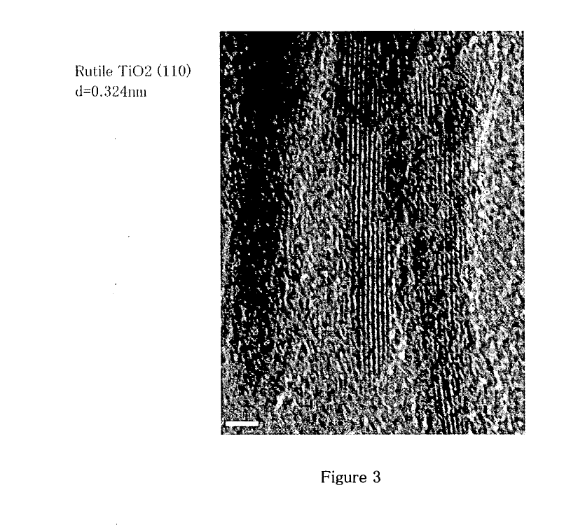

The aspect ratio of greater than 10 for the rutile nanoneedles of TiO₂ is as seen from HR-TEM, FIG. 3.

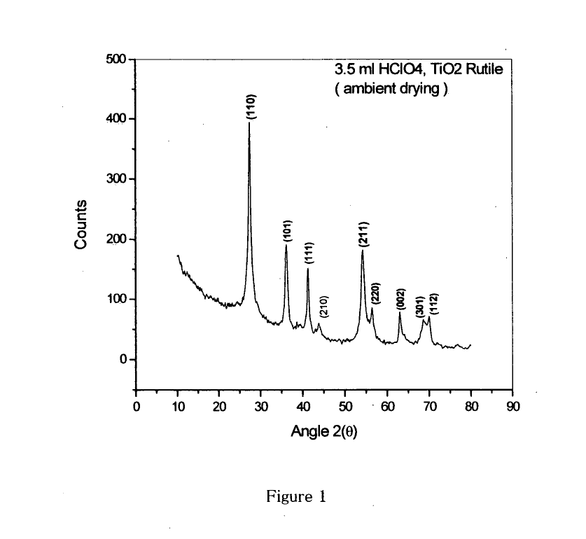

The rutile nanoneedles of high aspect ratio formed by the room temperature electrochemical process of the invention are characterized herein by XRD and HR-TEM as seen in FIGS. 1-3.

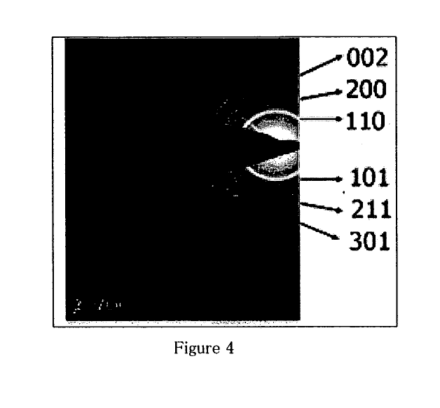

The TiO₂ is characterized by XRD data of FIG. 1 and HRTEM images in FIGS. 3 and 4.

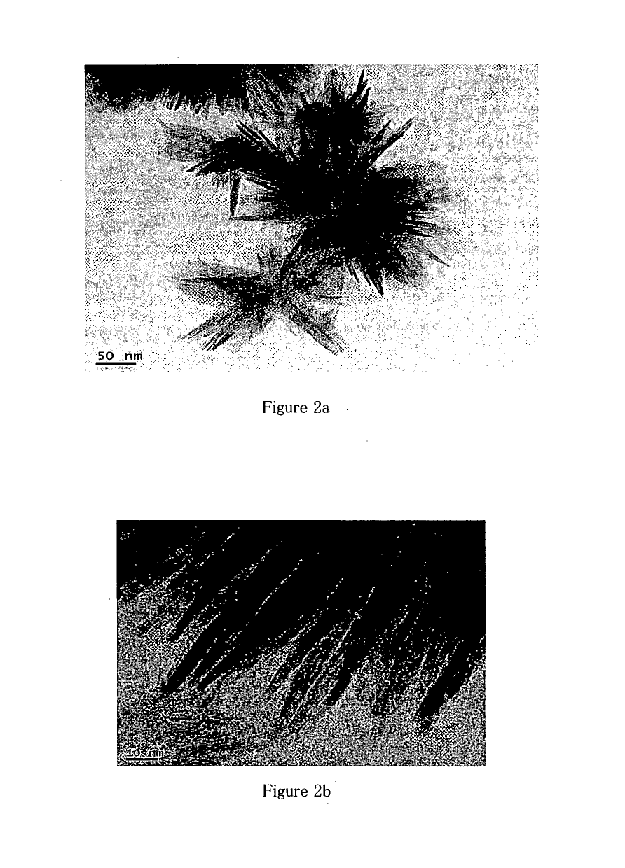

The nanoneedles of the invention are seen in HR-TEM-image of FIGS. 2 and 3.

The XRD data of FIG. 1 confirms the phase purity of rutile nanoneedles of titanium dioxide, as is further evident from FIGS. 2 and 3.

### EXAMPLE

Maintaining an anodizing bath of a solution of 3.5 ml of HClO₄ in 30 ml water at 25 deg C. Platinum was used as cathode and Titanium foil as anode and the distance between the foils was 1 cm. Applying electric voltages of the order of 8 volt between the two electrodes, resulting in the instantaneous evolution of hydrogen gas at cathode and anodic dissolution of Ti into rutile TiO₂ nanoneedles in the bath and washing the nanoneedles and air-drying at ambient temperature to obtain rutile titanium dioxide nanoneedles.

### Advantages of the Present Invention

1. The present invention provides an electrochemical process for the synthesis of rutile TiO₂ nanoneedles in one step only.
2. In the present invention pure rutile TiO₂ is formed.
3. No intermediate amorphous powder or anatase phase is formed and hence does not require any heat treatment to form rutile TiO₂ which reduces the time for synthesis and cost too.
4. The present invention has given significant improvement in the synthesis routes for phase pure rutile TiO₂ synthesis which will make it easier, cheaper and will take less time for its large scale synthesis to fulfill its ever increasing demands for applications such as photocatalysis and biomedicine etc.

We claim:

1. A one step electrochemical process for the synthesis of pure rutile titanium dioxide nanoneedles with high aspect ratio at room temperature, wherein the said process comprising the steps of :
a. maintaining a bath of a solution of mineral acid in water at room temperature ranging from 20-30° C., wherein the cathode is a noble metal and the anode is Ti;
b. applying electric voltages of the order of 8-30 volts between the two electrodes of step (a) stationed at about 1-2 cms apart, resulting in the instantaneous evolution of hydrogen gas at cathode and anodic dissolution of Ti into pure rutile TiO₂ nanoneedles in the bath ;
c. washing the nanoneedles as obtained in step (b) and air-drying at ambient temperature ranging between 20-30° C. to obtain rutile titanium dioxide nanoneedles with aspect ratio greater than 10.

2. A process as claimed in claim 1, wherein noble metal used for cathode in step (a) is platinum.

3. A process as claimed in claim 1, wherein mineral acid used in step (a) is HClO₄.

4. A process as claimed in claim 1, wherein the concentration of the acid solution in step (a) is to maintain pH below 2.

5. A process as claimed in claim 1, wherein Ti anode used in step (a) is selected from the group wire, foil, plate and rod.

6. A process as claimed in claims 1, Ti anode used in step (a) is a foil.

7. A process as claimed in claim 1, wherein current density in the foil surface is in the range of 80-120 mAmps/cm² for rutile phase titanium dioxide nanoneedles formation.

8. A process as claimed in claim 1, wherein thickness of Ti anode foil is at least 0.5 mm.
